(19) United States
(12) Patent Application Publication
(10) Pub. No.: US 2015/0350592 A1
(43) Pub. Date: Dec. 3, 2015

(54) ELECTRONIC DEVICE AND VIDEO DATA RECEIVING METHOD THEREOF

(71) Applicant: Wistron Corp., New Taipei City (TW)

(72) Inventor: Jun Xin QIU, New Taipei City (TW)

(21) Appl. No.: 14/556,478

(22) Filed: Dec. 1, 2014

(30) Foreign Application Priority Data
May 28, 2014 (CN) 201410232841.5

(51) Int. Cl. H04N 7/01; G06F 13/38; G06F 13/42

(52) U.S. Cl. CPC H04N 7/01; G06F 13/4282; G06F 13/387; H04N 7/0125

(57) ABSTRACT

An electronic device is provided. The electronic device includes a connector, a detecting unit, an image processing unit, a USB unit, and a switching unit. The detecting unit detects a voltage level of a specific pin of the connector, and provides a control signal. The USB unit is coupled to the image processing unit. According to the control signal, the switching unit selectively couples the connector to the image processing unit or the USB unit.

### CROSS REFERENCE TO RELATED APPLICATIONS

This Application claims priority of China Patent Application No. 201410232841.5, filed on May 28, 2014, the entirety of which is incorporated by reference herein.

### BACKGROUND OF THE INVENTION

1. Field of the Invention

The invention relates to an electronic device, and more particularly to a video data receiving method of an electronic device.

2. Description of the Related Art

Generally, electronic devices having connection ports can output image data to a big screen through the connection port so as to share with others. Electronic devices such as mobile phones, tablet personal computers and notebooks can output the content of a report to the monitor, television or projector by using a high-definition multimedia interface (HDMI), a mobile high-definition link (MHL), a video graphic array out (VGA out), a television out (TV out) or a super video (S-video also known as the separated video). Such electronic devices are disclosed in Taiwan Patent Application No. 201401163.

Mobile High-Definition Link (MHL) is a video standard interface for connecting portable consumer electronic devices, which can be presented on a high-definition TV by using a transmission line and through a standard HDMI input interface. HML uses a micro Universal Serial Bus (USB) interface. Therefore, mobile phones, digital cameras, or portable multimedia players can completely transmit the high-resolution multimedia data to the display for playing.

Therefore, when a connector of a display can supply both USB and MHL, a method for discriminating USB and MHL image data is desired.

### BRIEF SUMMARY OF THE INVENTION

Electronic devices and a video data receiving method thereof are provided. An embodiment of an electronic device is provided. The electronic device comprises a connector, a detecting unit, an image processing unit, a universal serial bus (USB) unit coupled to the image processing unit and a switching unit. The detecting unit detects a voltage level of a specific pin of the connector, and provides a control signal. The switching unit selectively couples the connector to the image processing unit or the USB unit according to the control signal.

Furthermore, an embodiment of a video data receiving method for an electronic device is provided, wherein the electronic device comprises a connector. A voltage level of a specific pin of the connector is detected to provide a control signal when an external device is coupled to the connector of the electronic device via a transmission line. Video data from the external device is converted into a low-voltage differential signaling (LVDS) signal according to the control signal. The control signal indicates that the video data is a mobile high-definition link (MHL) signal or a universal serial bus (USB) signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a multimedia display system according to an embodiment of the invention;

FIG. 2 shows an electronic device according to another embodiment of the invention;

FIG. 3 shows a multimedia display system according to another embodiment of the invention; and

FIG. 4 shows a video data receiving method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

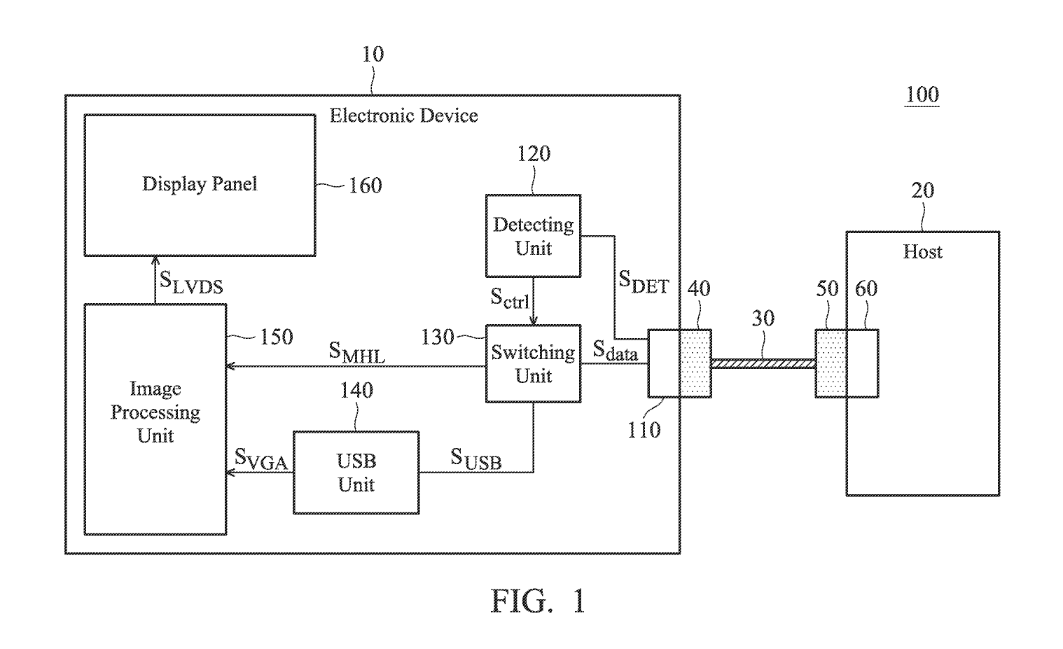

FIG. 1 shows a multimedia display system 100 according to an embodiment of the invention. The multimedia display system 100 comprises an electronic device 10 and a host 20, wherein the electronic device 10 is coupled to the host 20 via a cable 30. In the embodiment, a connector 40 of the cable 30 is coupled to a connector 110 of the electronic device 10, and a connector 50 of the cable 30 is coupled to a connector 60 of the host 20. When the host 20 is coupled to the electronic device 10 via the cable 30, the host 20 transmits video or multimedia data to the electronic device 10 via the cable 30. In FIG. 1, the electronic device 10 is a display apparatus, which comprises the connector 110, a detecting unit 120, a switching unit 130, a universal serial bus (USB) unit 140, an image processing unit 150 and a display panel 160. In the embodiment, the cable 30 may be a USB transmission line or a mobile high-definition link (MHL) transmission line. Furthermore, the connector 40 of the cable 30 is a plug that conforms to a micro USB standard, and the connector 110 of the electronic device 10 is a receptacle that conforms to a micro USB standard. Therefore, when the cable 30 is coupled to the electronic device 10, the electronic device 10 further determines whether the cable 30 is a USB transmission line or a MHL transmission line for subsequent processes. In the embodiment, the host 20 may be a mobile phone, a tablet PC or a notebook.

In FIG. 1, when the connector 40 of the cable 30 is coupled to the connector 110 of the electronic device 10, the detecting unit 120 detects a specific pin of the connector 110, to obtain a voltage level S_{DET} of the specific pin, and provides a control signal S_{ctrl} to the switching unit 130 according to the voltage level S_{DET} of the specific pin. Next, the switching unit 130 selectively couples the connector 110 to the USB unit 140 or the image processing unit 150 according to the control signal S_{ctrl}. Specifically, when the detecting unit 120 determines that the cable 30 is a USB transmission line according to the voltage level S_{DET} of the specific pin, the detecting unit 120 provides the control signal S_{ctrl} to the switching unit 130, so as to couple the connector 110 to the USB unit 140. Thus, video data S_{data} from the host 20 can be transmitted to the USB unit 140 via the switching unit 130, i.e. the video data S_{data} is a USB signal S_{USB}. In the embodiment, the USB unit 140 comprises a Graphics Processing Unit (GPU) for converting the USB signal S_{USB} into a Video Graphics Array (VGA) signal S_{VGA} and providing the VGA signal S_{VGA} to the image processing unit 150. In other embodiments, the USB unit 140 may convert the USB signal into a Digital Visual Interface (DVI) signal or a High Definition Multimedia Interface (HDMI) signal. Moreover, the image processing unit 150 may be a video scaler or a video converter, and the image processing unit 150 is capable of converting the received video signal into a specific format signal, so as to drive the display panel 160. In the embodiment, the image processing unit 150 converts the VGA signal S_{VGA} from the USB unit 140 into a Low-Voltage Differential Signaling (LVDS) signal S_{LVDS}, and provides the LVDS signal S_{LVDS} to the display panel 160, wherein the LVDS signal S_{LVDS} can meet requirements for high-performance data transmission applications nowadays, and it can decrease the operating voltage to 2 volts, making it suitable for high-resolution display panel. Conversely, when the detecting unit 120 determines that the cable 30 is a MHL transmission line according to the voltage level S_{DET} of the specific pin, the detecting unit 120 provides the control signal S_{ctrl} to the switching unit 130, so as to couple the connector 110 to the image processing unit 150. Thus, the video data S_{data} from the host 20 is transmitted to the image processing unit 150 via the switching unit 130, i.e. the video data S_{data} is a MHL signal S_{MHL}. Next, the image processing unit 150 converts the MHL signal S_{MHL} into the LVDS signal S_{LVDS}, and provides the LVDS signal S_{LVDS} to the display panel 160. In other embodiments, the image processing unit 150 may convert the MHL signal, VGA signal, DVI signal or HDMI signal into the LVDS signal, TTL signal, V×1 signal or eDP signal.

In FIG. 1, when the host 20 is coupled to the electronic device 10 via the cable 30, the electronic device 10 can determine the type of cable 30 according to the voltage level S_{DET} at the specific pin of the connector 110. The following Table 1 illustrates pin definitions of connectors of traditional cables.

TABLE 1

Signal Type

| Pin Number | MHL | USB 2.0 | USB 3.0 |
|---|---|---|---|
| 1 | VBUS | VBUS | VBUS |
| 2 | MHL− | D− | D− |
| 3 | MHL+ | D+ | D+ |
| 4 | CBUS | ID | ID |
| 5 | GND | GND | GND |
| 6 | | | SSTX− |
| 7 | | | SSTX+ |
| 8 | | | GND_DRAIN |
| 9 | | | SSRX− |
| 10 | | | SSRX+ |
| 11 | | | protection |
| | | | (shield) |

As shown in Table 1, if the cable 30 is an MHL transmission line, the display apparatus 10 (e.g. a mobile device) can provide power to the host 20 via the first pin for charging. Furthermore, the host 20 (e.g. a mobile device) can provide a pair of differential signals MHL− and MHL+ via the second pin and the third pin. Moreover, the host 20 can provide a control signal CBUS via the fourth pin for bidirectional communication or control between the display apparatus 10 and the host 20 (e.g. a mobile device), and the host 20 can provide a grounding signal GND via the fifth pin. Furthermore, if the cable 30 is a USB 2.0 transmission line or a USB 3.0 transmission line, the host 20 can provide a power signal VBUS to power the coupled device via the first pin. Moreover, the host 20 can provide a pair of differential signals D− and D+ via the second pin and the third pin. In addition, the host 20 provides an identification signal ID via the fourth pin, and the host 20 provides the grounding signal GND via the fifth pin. Furthermore, if the cable 30 is a USB 3.0 transmission line, the host 20 can further provide a pair of differential signals SSTX− and SSTX+ via the sixth pin and the seventh pin. Moreover, the host 20 can provide a grounding signal GND DRAIN via the eighth pin. In addition, the host 20 can provide a pair of differential signals SSRX− and SSRX+ via the ninth pin and the tenth pin. Therefore, in order to identify the type of the cable 30, according to the embodiments, the eighth pin of the connector of the USB 2.0 transmission line can be grounded. Thus, for the connector of the USB 2.0 or USB 3.0 transmission line, the eighth pin is grounded. On the other hand, in the connector of the MHL transmission line, the eighth pin is no connection (NC), i.e. floating.

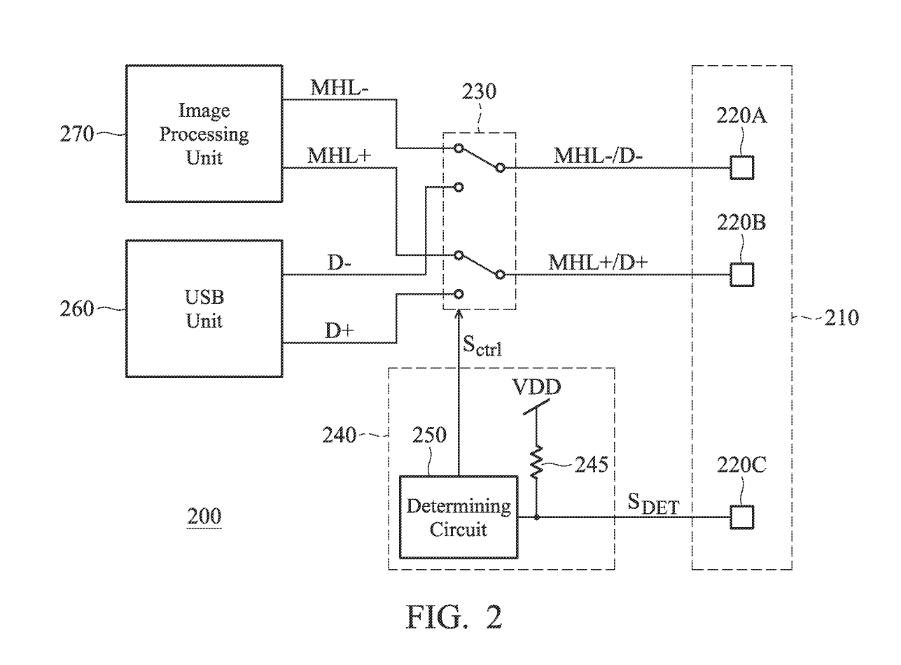

FIG. 2 shows an electronic device 200 according to another embodiment of the invention. The electronic device 200 comprises a connector 210, a switching unit 230, a detecting unit 240, a USB unit 260 and an image processing unit 270. To simplify the description, the electronic device 200 only comprises the main circuits for determining the type of transmission line (e.g. the cable 30 of FIG. 1) coupled to the connector 210. The connector 210 comprises the pins 220A, 220B and 220C, wherein the pin 220A corresponds to the second pin of Table 1, the pin 220B corresponds to the third pin of Table 1, and the pin 220C corresponds to the eighth pin of Table 1. In FIG. 2, when the transmission line is coupled to the connector 210, the detecting unit 240 detects the voltage level S_{DET} at the pin 220C, and provides the control signal S_{ctrl} to the switching unit 230 according to the voltage level S_{DET}. In the embodiment, the detecting unit 240 comprises a pull-up resistor 245 and a determining circuit 250. The pull-up resistor 245 is coupled between the pin 220C and a power VDD. The determining circuit 250 is coupled to the pull-up resistor 245 for determining the voltage level S_{DET}. If the transmission line is a MHL transmission line, the eighth pin of a connector of the MHL transmission line is floating. Thus, the voltage level S_{DET} of the pin 220C is pulled to a high voltage level via the pull-up resistor 245. Therefore, the determining circuit 250 can determine that the transmission line coupled to the connector 210 is a MHL transmission line, and then provides the control signal S_{ctrl} to the switching unit 230, so as to couple the pins 220A and 220B to the image processing unit 270. Thus, the differential signals MHL− and MHL+ from the MHL transmission line are transmitted to the image processing unit 270 via the switching unit 230. As described above, the image processing unit 270 can provide the LVDS signal S_{LVDS} to a display panel according to the differential signals MHL- and MHL+. Conversely, if the transmission line is a USB transmission line, the eighth pin of the connector of the USB transmission line is grounded. Thus, the voltage level S_{DET} of the pin 220C is pulled down to a low voltage level, i.e. the voltage level S_{DET} is a low voltage level. Therefore, the determining circuit 250 can determine that the transmission line of the connector 210 is a USB transmission line, and provides the control signal S_{ctrl} to the switching unit 230, so as to couple the pins 220A and 220B to the USB unit 260. Thus, the differential signals D- and D+ from the USB transmission line are transmitted to the USB unit 260 via the switching unit 230. As described above, the USB unit 260 can convert the differential signals D- and D+ into a VGA signal S_{VGA}, and provide the VGA signal S_{VGA} to the image processing unit 270. Next, the image processing unit 270 provides the LVDS signal S_{LVDS} to the display panel according to the VGA signal S_{VGA}. Therefore, when the transmission line is coupled to the connector 210, a type of the transmission line is determined by detecting the voltage level S_{DET} of the pin 220C of the connector 210.

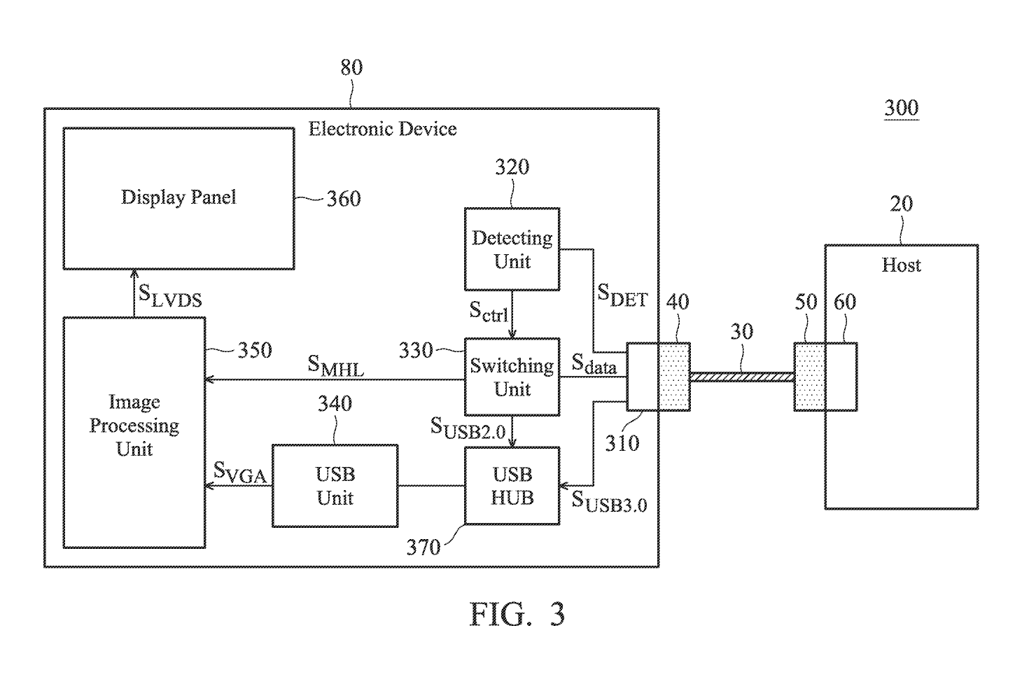

FIG. 3 shows a multimedia display system 300 according to another embodiment of the invention. The multimedia display system 300 comprises an electronic device 80 and a host 20, wherein the electronic device 80 is coupled to the host 20 via a cable 30. In the embodiment, a connector 40 of the cable 30 is coupled to the connector 310 of the electronic device 80, and a connector 50 of the cable 30 is coupled to a connector 60 of the host 20. When the host 20 is coupled to the electronic device 80 via the cable 30, the host 20 transmits video or multimedia data to the electronic device 80 via the cable 30. The electronic device 80 is a display apparatus, which comprises a connector 310, a detecting unit 320, a switching unit 330, a USB unit 340, an image processing unit 350, a display panel 360 and a USB HUB370, and also can be coupled to a user input device, e.g. a touch screen or a stylus, so as to control the host 20 (e.g. a mobile device). For example, the user input device (e.g. a keypad) can control the host 20 (e.g. a mobile device) via the electronic device 80. In the embodiment, the cable 30 may be a USB 2.0 transmission line, a USB 3.0 transmission line or a MHL transmission line. If the cable 30 is a USB 3.0 transmission line, a USB 3.0 signal S_{USB3.0} is transmitted to the USB HUB 370 via the connector 310. Next, the USB HUB 370 transmits the USB 3.0 signal S_{USB3.0} to the USB unit 340. Next, the USB unit 340 converts the USB 3.0 signal S_{USB3.0} into a video signal S_{VGA}. Next, the image processing unit 350 converts the video signal S_{VGA} into the LVDS signal S_{LVDS}, and provides the LVDS signal S_{LVDS} to the display panel 360. If the cable 30 is a USB 2.0 transmission line or a MHL transmission line, the detecting unit 320 can determine the type of the cable 30 according to the voltage level S_{DET} at the eighth pin of connector 310. If the voltage level S_{DET} is a low voltage level, the detecting unit 320 determines that the cable 30 is a USB 2.0 transmission line, and provides the control signal S_{ctrl} to the switching unit 330. Next, the switching unit 330 couples the connector 310 to the USB HUB 370. Thus, the video data S_{data} from the host 20 is transmitted to the USB HUB 370 via the switching unit 330, i.e. the video data S_{data} is a USB 2.0 signal S_{USB2.0.} Next, the USB HUB 370 translates the USB 2.0 signal S_{USB2.0} into the USB 3.0 signal S_{USB3.0}, and transmits the USB 3.0 signal S_{USB3.0} to the USB unit 340. Next, the USB unit 340 converts the USB 3.0 signal S_{USB3.0} into the video signal S_{VGA}. Next, the image processing unit 350 converts the video signal S_{VGA} into the LVDS signal S_{LVDS}, and provides the LVDS signal S_{LVDS} to the display panel 360. Conversely, if the voltage level S_{DET} is a high voltage level, the detecting unit 320 determines that the cable 30 is a MHL transmission line, and provides the control signal S_{ctrl} to the switching unit 330. Next, the switching unit 330 couples the connector 310 to the image processing unit 350. Thus, the video data S_{data} from the host 20 is transmitted to the image processing unit 350 via the switching unit 330, i.e. the video data S_{data} is the MHL signal S_{MHL}. Next, the image processing unit 350 converts the MHL signal S_{MHL} into the LVDS signal S_{LVDS}, and provides the LVDS signal S_{LVDS} to the display panel 360.

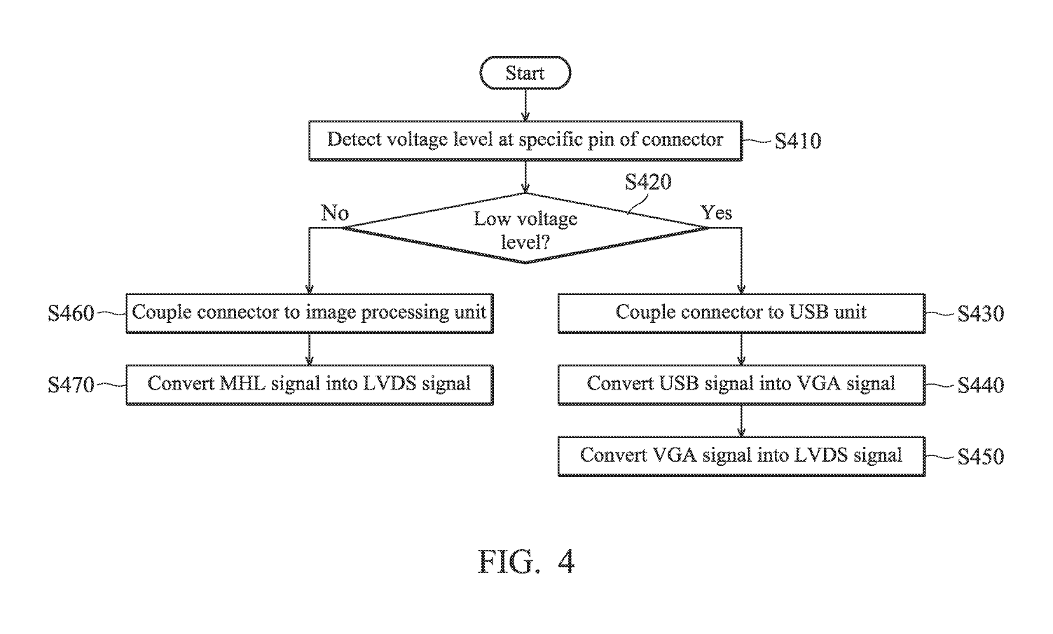

FIG. 4 shows a video data receiving method according to an embodiment of the invention. Referring to FIG. 1 and FIG. 4 together, first, in step S410, when the connector 40 of the cable 30 is coupled to the connector 110 of the electronic device 10, the detecting unit 120 detects the voltage level S_{DET} at the specific pin (the eighth pin) of the connector 110. Next, it is determined whether the voltage level S_{DET} is a low voltage level (step S420). If the voltage level S_{DET} is a low voltage (i.e. the cable 30 is a USB transmission line), the switching unit 330 couples the connector 110 to the USB unit 140 according to the control signal S_{ctrl} (step S430). Next, in step S440, the USB unit 140 converts the USB signal S_{USB} into the VGA signal S_{VGA}. Next, in step S450, the image processing unit 150 converts the VGA signal S_{VGA} into the LVDS signal S_{LVDS}, and provides the LVDS signal S_{LVDS} to the display panel 160 for playing. Conversely, if the voltage level S_{DET} is a high voltage level (i.e. the cable 30 is a MHL transmission line), the switching unit 130 couples connector 110 to the image processing unit 150 according to the control signal S_{ctrl} (step S460). Next, in step S470, the image processing unit 150 converts the MHL signal S_{MHL} into the LVDS signal S_{LVDS}, and provides the LVDS signal S_{LVDS} to the display panel 160 for playing.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a connector;
a detecting unit, detecting a voltage level of a specific pin of the connector and providing a control signal;
an image processing unit;
a universal serial bus (USB) unit coupled to the image processing unit; and
a switching unit, selectively coupling the connector to the image processing unit or the USB unit according to the control signal.

2. The electronic device as claimed in claim 1, wherein the connector is a receptacle that conforms to a micro USB standard.

3. The electronic device as claimed in claim 2, wherein the specific pin is an eighth pin of the receptacle.

4. The electronic device as claimed in claim 1, wherein the detecting unit comprises:
a pull-up resistor coupled to the specific pin of the connector; and
a determining circuit coupled to the specific pin of the connector, determining the voltage level of the specific pin of the connector when the connector is coupled to an external device via a transmission line, to generate the control signal.

5. The electronic device as claimed in claim 4, wherein when the determining circuit determines that the specific pin of the connector has a low voltage level, the switching unit couples the connector to the USB unit, so as to provide a USB signal from the external device to the USB unit.

6. The electronic device as claimed in claim 5, wherein the low voltage level of the specific pin of the connector is provided by the transmission line.

7. The electronic device as claimed in claim 5, wherein the USB unit converts the USB signal into a video signal, and provides the video signal to the image processing unit.

8. The electronic device as claimed in claim 7, further comprising:
a display panel coupled to the image processing unit;
wherein the image processing unit provides a low-voltage differential signaling (LVDS) to the display panel according to the video signal.

9. The electronic device as claimed in claim 4, wherein when the determining circuit determines that the specific pin of the connector has a high voltage level, the switching unit couples the connector to the image processing unit, so as to provide a mobile high-definition link (MHL) signal from the external device to the image processing unit.

10. The electronic device as claimed in claim 9, further comprising:
a display panel coupled to the image processing unit;
wherein the image processing unit provides a low-voltage differential signaling to the display panel according to the MHL signal.

11. A video data receiving method for an electronic device, wherein the electronic device comprises a connector, the method comprising:
detecting a voltage level of a specific pin of the connector to provide a control signal when an external device is coupled to the connector of the electronic device via a transmission line; and
converting a video data from the external device into a low-voltage differential signaling (LVDS) signal according to the control signal;
wherein the control signal indicates that the video data is a mobile high-definition link (MHL) signal or a universal serial bus (USB) signal.

12. The video data receiving method as claimed in claim 11, wherein the electronic device further comprises:
an image processing unit;
a USB unit coupled to the image processing unit;
a pull-up resistor coupled to the specific pin of the connector; and
a switching unit, selectively coupling the connector to the image processing unit or the USB unit according to the control signal.

13. The video data receiving method as claimed in claim 11, wherein the connector is a receptacle that conforms to a micro USB standard.

14. The video data receiving method as claimed in claim 13, wherein the specific pin is an eighth pin of the receptacle.

15. The video data receiving method as claimed in claim 12, further comprising:
providing the control signal to the switching unit when it is determined that the specific pin of the connector has a low voltage level, so as to couple the connector to the USB unit;
providing the USB signal from the external device to the USB unit via the switching unit;
converting the USB signal into a video signal by the USB unit; and
converting the video signal into the LVDS signal by the image processing unit.

16. The video data receiving method as claimed in claim 15, wherein the low voltage level of the specific pin of the connector is provided by the transmission line.

17. The video data receiving method as claimed in claim 12, further comprising:
providing the control signal to the switching unit when it is determined that the specific pin of the connector has a high voltage level, so as to couple the connector to the image processing unit;
providing the MHL signal from the external device to the image processing unit via the switching unit; and
converting the MHL signal into the LVDS signal by the image processing unit.
